(19) United States
(12) Patent Application Publication
(10) Pub. No.: US 2025/0190184 A1
(43) Pub. Date: Jun. 12, 2025

(54) METHOD FOR GENERATING A CONTROL PROGRAM FOR A TARGET PLATFORM, DEVICE FOR DATA PROCESSING, COMPUTER PROGRAM PRODUCT AND DATA CARRIER

(71) Applicant: dSPACE GmbH, Paderborn (DE)

(72) Inventors: Joerg NIERE, Paderborn (DE); Felix ENGEL, Paderborn (DE)

(73) Assignee: dSPACE GmbH, Paderborn (DE)

(21) Appl. No.: 18/972,215

(22) Filed: Dec. 6, 2024

(30) Foreign Application Priority Data
Dec. 6, 2023 (EP) 23214679.5

(51) Int. Cl. G06F 8/35; G06F 8/34

(52) U.S. Cl. CPC G06F 8/35; G06F 8/34

(57) ABSTRACT

A computer-implemented method for generating a control program for a target platform from a graphical control model of a development platform, wherein the development platform comprises a definition database for storing information on the graphical control model and is designed to support matrix operations. Annotation information for the structure of matrices used in the graphical control model can be stored in the definition database and that when the control program for the target platform is generated, the stored annotation information is taken into account in such a way that a) on the target platform, when implementing a processing order that involves at least one matrix, the computing speed is increased and/or b) on the target platform, when saving the matrices, the memory requirement is reduced.

This nonprovisional application claims priority under 35 U.S.C. § 119(a) to European Patent Application No. 23214679.5, which was filed on Dec. 6, 2023, and which is herein incorporated by reference.

### BACKGROUND OF THE INVENTION

### Field of the Invention

The invention relates to a computer-implemented method for generating a control program for a target platform from a graphical control model of a development platform.

Furthermore, the invention relates to a method for configuring a target platform designed as a control unit, in which a control program for the target platform is generated from a graphical control model that is read in according to the above method.

In addition, the invention relates to a device for data processing, comprising means for carrying out the above method.

Furthermore, the invention relates to a computer program product, comprising commands which, when executed by a computer, cause it to execute the above method.

The invention also relates to a computer-readable medium on which the above computer program product is stored.

### Description of the Background Art

Methods for the computer-aided generation of a control program from a graphical control model have been known for some time now and are among the basic functionalities of development environments. In particular, programs can be created this way for control systems such as control units.

The graphical control model is often available in the form of a block diagram, which is used, for example, to model and represent the mathematical functionality of a control algorithm. By means of the graphical control model, processes, controllers and/or generally the behavior of the control unit can first be simulated and the presence of desired properties can be checked. The block diagram that forms the model usually includes several blocks connected by signal connections that perform operations such as calculations, wherein one block can, for example, calculate an output signal from several input signals. As a rule, block diagrams are executed cyclically, wherein all blocks are kept in memory permanently and each block is executed once per time step. In particular, a block can apply one or more operations to input signals from the last time step to generate output signals of the current time step. Accordingly, common assumptions with respect to control programs, such as the lifetime of variables of the control program, cannot be easily transferred to the graphical control model.

In addition to a cyclically executed submodel for the description of approximately time-continuous behavior of the control unit, graphical control models can also include a submodel for the description of a discrete behavior in which a number of states and transition conditions are defined.

Methods for generating control programs from graphical control models are also referred to as code generators. This is a computer program that translates the graphical control model into the source code of the selected target platform—i.e., into the control program. In contrast to the graphical control model, the control program is available in completely textual form and includes instructions for execution on the target platform. Code generators thus ensure a reliable and error-free implementation of an abstract function description (graphical control model) in a program for the target platform (control system).

A method for generating a control program is described, for example, in the document DE 10 2020 124 080 A1 (which corresponds to US 2021/0096830) or the document EP 2 916 183 B1 (which corresponds to US 2015/0255038), which are all herein incorporated by reference.

Control systems such as control units are often subject to resource constraints in terms of available memory and/or computing speed. At the same time, the data to be processed is constantly increasing, especially in the automotive sector, because, for example, the resolution of data-collecting devices such as cameras is improving. In addition, the necessary control programs are also becoming more complex due to the development towards driver assistance systems, (highly) automated driving and/or autonomous driving. For example, mathematical methods for iterative estimation of parameters are used to describe system states on the basis of error-prone observations (Kalman Filter) or methods for predictive control of complex and usually multi-variable processes, such as Model Predictive Control (MPC). This leads to a high demand on the resources of the control unit.

### SUMMARY OF THE INVENTION

It is therefore an object of the invention to specify measures to enable improved utilization of the resources of the control unit and/or to specify measures to generate more resource-efficient control programs.

Thus, according to an example of the invention, a computer-implemented method for generating a control program for a target platform is provided from a graphical control model of a development platform, wherein the development platform comprises a definition database for storing information on the graphical control model and is designed to support matrix operations, wherein in the definition database annotation information is stored for the construction of matrices that can be stored in the graphical control model, and when generating the control program for the target platform, the stored annotation information is taken into account in such a way that on the target platform, when implementing a processing order that involves at least one matrix, the computing speed is increased and/or on the target platform when saving the matrices, the memory requirement is reduced.

In other words, the method according to the invention uses the stored annotation information concerning the matrices to generate the control program, i.e., source code, which is optimized in such a way that the computational speed is increased for processing jobs involving a matrix as compared to source code generated from the graphical control model without taking into account the stored annotation information. Alternatively or additionally, the generated source code is optimized in such a way that the memory requirement for storing the matrices is reduced, also as compared to source code generated from the graphical control model without taking into account the stored annotation information. The advantage is that the annotation information is stored and automatically used during code generation in order to generate an optimized application runtime and/or an optimized memory utilization in the control program for the control unit. This approach is far less error-prone than if a programmer were to manually consider the structure of the matrix when implementing the source code.

Computing speed can be understood to be the speed at which a processing job is executed on the target platform. Increased computing speed is reflected in the shortened time span that the target platform needs in order to complete a processing order. In other words, it leads to a reduction in the runtime of the control program.

The control program—also known as source code—may be available in completely textual form and preferably includes instructions for the control unit.

In the present case, a matrix can be understood to be an n×m system with n≥1 and m≥1. A matrix can therefore also be a system with n=1 and/or m=1. In contrast to a vector, which in the present case can be understood to be a disoriented n-tuple of values, which in other words has only a length n, the matrix is thus not disoriented. Due to the lack of orientation of a vector, it can be interpreted as a column or row matrix. A matrix can be implemented in a programming language as a 2D array. In this case, the matrix is a fixed-size block of memory. Alternatively, the matrix can be implemented as a set of tuples (row, column, value). In this case, the size of the matrix depends on the entries that do not match the default value (typically 0).

Preferably, the graphical control model is in the form of a block diagram, which preferably comprises a large number of blocks that are connected to each other via signal connections. The blocks in the block diagram can be atomic, i.e., form a unit from the point of view of the surrounding blocks, in which all input signals must be present at the beginning of a calculation step and all output signals must be present at the end of a calculation step. If block diagrams are hierarchical, a large number of blocks in a subordinate level can describe the structure of a block in a superordinate level. Hierarchical or composite blocks, even if they are atomic, can comprise a large number of blocks in a subordinate level. Compound blocks can be subsystems, in particular; Subsystems can have additional properties, such as being implemented in a separate function and/or triggering the execution of the subsystem via a dedicated signal. Special blocks can be arranged in subsystems to further specify the properties of the subsystem.

Data or signals can be transmitted via the signal connection; here, a first block outputs a value or, depending on the definition, several related values, and a subsequent second block receives these as its input signal and takes them into account when determining its output signal—i.e., when determining one or more related output values. Signals can contain scalar variables and/or structured data types such as arrays, or they can be formed as matrices. Within the blocks, matrix operations can be performed, for example, to determine the output signal of the block.

In particular, if matrices are used in the graphical control model, this is associated with access to a multi-component variable, which means that when the graphical control model is converted into source code, a lot of source code is generated without knowledge of the structure of the matrix, as each component of the matrix has to be processed individually. On the other hand, if the structure of the matrix is known, i.e., via the annotation information stored in the definition database for the structure of the matrices, the source code can be generated in a form in which the computational speed is increased and/or the memory requirement is reduced. In other words, a semantic definition of the annotations enables the code generator to generate an optimal memory storage of the matrices and/or optimal code patterns in the source code when implementing the matrix operations.

According to an example of the invention, it is provided in this context that when the control program is generated, the stored annotation information is taken into account in such a way that when the processing order involving at least one matrix is implemented, fewer calculation steps are required, and/or fewer accesses to the matrix are required on the target platform.

In other words, the source code is generated in such a way that the processing order is implemented with fewer calculation steps and/or that the processing order is implemented with fewer accesses to the matrix.

With regard to fewer calculation steps and/or fewer accesses, it is possible, especially in the case of matrix multiplications as well as matrix additions and matrix subtractions as processing order, to cut down on calculation steps if the structure of the matrix is known.

If, for example, it is known from the annotation information that two matrices involved in a matrix multiplication are each an upper triangular matrix, then steps can be omitted from the calculation of the matrix multiplication because the product of two upper triangular matrices is also an upper triangular matrix. The same applies to the lower triangle matrix and the strict upper or strict lower triangle matrix. A triangle matrix is a square matrix that is characterized in that all entries below (upper triangle matrix) or above (lower triangle matrix) the main diagonal are zero. In addition, it is a strict triangle matrix (also known as a true triangle matrix) when all entries on the main diagonal are also zero.

In another example, calculation steps can be reduced if it is known from the annotation information that a matrix involved in matrix multiplication is an upper or lower triangular matrix and it is also known that the values on the main and/or secondary diagonal have the same value. In this example, steps can be removed from the calculation because the coefficients result from the constants or even equal zero. In extreme cases, the calculation could be completely omitted if in the matrix product C=AB, the matrix A is a lower triangle matrix with zero on the main diagonal (i.e., a strict lower triangle matrix) and B is an upper triangle matrix.

In addition, computational steps can also be reduced if it is known on the basis of the annotation information that only a few elements of the matrices involved in matrix multiplication are non-zero, in other words they are two sparse matrixes. A calculation of the matrix product C=AB in such a way that the matrix C is initially created with zero and only those elements that are non-zero are calculated in individual steps may lead to fewer calculation steps than the classical evaluation of the matrix product with two sparse matrices A, B. A sparse matrix is a matrix in which many entries are formed of zeros. In this case, a sparse matrix is referred to here if the number of non-zero elements is not greater than the number of rows or columns.

In another example, computational steps can be reduced if it is known from the annotation information that a matrix involved in a multiplication of a matrix by a column matrix is a diagonal matrix. A diagonal matrix is a square matrix in which all elements outside the main diagonal are zero. Without knowledge of the structure of the matrix, for example, multiplying a 5×4 matrix by a 5×1 column matrix would require a total of 5*5=25 multiplications and 5*4=20 additions. If, on the other hand, it is known that the 5×4 matrix is a diagonal matrix, only 5 multiplications are necessary. If it is also known that the values on the diagonal of the diagonal matrix are the same, four more accesses to the matrix are omitted, since the common value can be cached in a register. When multiplying a matrix by a column matrix, the result is a matrix and in particular a column matrix, i.e., an n×m system with m=1.

The multiplication described above can also be a matrix-vector multiplication, i.e., a multiplication of a matrix by a disoriented n-tuple. In this case, the result of the matrix-vector multiplication is a vector, not a column matrix. The explanations about saving calculation steps apply in the same way.

The same applies to the evaluation of a product of a matrix by a column matrix if the matrix is a sparse matrix. This can be done very efficiently by not taking the zeros into account in the calculation of the product. Here, too, the column matrix can be a vector.

In other words, it is preferably provided that the annotation information characterizes the matrix as an upper triangle matrix, lower triangle matrix, diagonal matrix, band matrix, matrix with equal values on the main diagonal, matrix with equal values on the secondary diagonal, unit matrix, symmetric matrix, sparse matrix, permutation matrix and/or regular matrix, and in a matrix multiplication, those calculation steps are omitted in which the component-by-component multiplication results in zero, and/or in a matrix addition and/or matrix subtraction, those calculation steps are omitted in which two zero elements are added together or subtracted from each other.

A band matrix is a matrix in which, in addition to the main diagonal, only a certain number of secondary diagonals have non-zero elements. The band matrix is therefore a sparse matrix with a special structure. The unit matrix (also known as the identity matrix) is a square matrix whose elements are one on the main diagonal and zero everywhere else. A symmetric matrix is a square matrix whose entries are mirror symmetric with respect to the main diagonal. A symmetric matrix is thus equal to its transpose. A permutation matrix (also known as a reordering matrix) is a matrix in which there is exactly one entry in each row and in each column, and all other entries are zero. A regular matrix (also known as an invertible or non-singular matrix) is a square matrix that has an inverse.

With regard to fewer calculation steps and/or fewer accesses, it is also possible to cut down on calculation steps in the case of matrix decompositions as a processing order if the structure of the matrix is known: If, for example, it is known that the matrix is a symmetrical positive definite matrix, a Cholesky decomposition (also called Cholesky factorization) can be used to decompose the matrix A into a product of a lower triangular matrix L, a diagonal matrix D and the transposes of the lower triangular matrix LT. Since the Cholesky decomposition works faster than other decomposition methods, taking the annotation information into account leads to fewer computational steps and ultimately to a resource-saving control program.

The same applies to an LR decomposition (also called LU decomposition or triangular decomposition), in which a matrix A is decomposed into a product of a lower left normalized triangular matrix L and a right upper triangular matrix R. The prerequisite for the LR decomposition is that the matrix A is a regular matrix, i.e., a square matrix that has an inverse.

In other words, it is preferably provided that the annotation information characterizes the matrix as an upper triangle matrix, lower triangle matrix, diagonal matrix, band matrix, matrix with equal values on the main diagonal, matrix with equal values on the secondary diagonal, unit matrix, symmetric matrix, sparse matrix, permutation matrix and/or regular matrix, and in a decomposition of the matrix a decomposition procedure adapted to the properties of the matrix is carried out.

Another advantage of the annotation information is that the code generator can be enabled to respond to hardware-specific characteristics of the target platform—i.e., the control unit. In this context, according to a further preferred further development of the invention, it is provided that the target platform comprises at least two computing units for the implementation of processing orders, wherein the stored annotation information is taken into account when generating the control program in such a way that it is determined which of the computing units is used for the implementation of the processing order involving at least one matrix. The two computing units can preferably be two differently designed computing units such as a main processing unit (CPU), a graphics processing unit (GPU) and/or a tensor processing unit (TPU). The method of the invention makes it possible that when translating the graphical control model into source code, the source code makes use not only of the first computing unit, but also of the second computing unit. The method therefore preferably enforces that the graphical control model is calculated on the target platform on both the first computing unit and the second computing unit, so that a better use of resources results overall. In particular, when generating the control program for the target platform from a graphical control model, the system checks whether it is worthwhile in terms of application runtime to transfer parts of the generated source code from the first computing unit to the second computing unit and to transfer the result of the calculation back again.

As already mentioned, the annotation information stored in the definition database for the structure of matrices used in the graphical control model can be taken into account when generating the control program for the target platform not only in such a way that the computing speed is increased on the target platform when implementing the processing order involving at least one matrix, but can also be taken into account in such a way that when saving the matrices, the memory requirement is reduced on the target platform. In this context, according to a further preferred further development of the invention, it is provided that when the control program is generated, the stored annotation information is taken into account in such a way that when the matrix is stored, a matrix is stored as an array, or two matrices are stored together in a matrix on the target platform.

For example, for a lower triangle matrix, the null elements in the upper half can be omitted when saving to memory in that an array stores only those values that are necessary for a lower triangle matrix. However, the information that the array is a lower triangle matrix is taken into account in a subsequent operation on the basis of the annotation information.

In another example, a diagonal matrix can be stored as an array by storing only the diagonal elements. This means, for example, that a matrix of size 5×5 does not have to store 25 elements, but only an array of size 5. The same is true for a band matrix in which only the values and size of the band need to be saved.

It is possible to conserve even further memory if the matrix is a diagonal matrix of size n with equal values on the diagonal or even a unit matrix: a unit matrix of size n is implicitly described by the annotation information and does not have to be explicitly implemented by an n×n sized matrix. In the case of the diagonal matrix of size n with equal values on the diagonal, it can be completely described by an array of length 2 and specifying the size of the matrix and the value of the diagonal elements. In other words, the annotation information makes it possible to store the structure of the matrix as a compact description instead of explicitly listing all elements of the matrix.

In the case of a sparse matrix, it can also be advantageous not to store all the elements of the matrix, but only the elements that are different from zero and their corresponding position in the matrix.

In other words, it is preferably provided that the annotation information characterizes the matrix as an upper triangle matrix, lower triangle matrix, diagonal matrix, band matrix, matrix with equal values on the main diagonal, matrix with equal values on the secondary diagonal, unit matrix, symmetric matrix, sparse matrix, permutation matrix and/or regular matrix, and when the matrix is saved, the matrix is stored as an array and those elements of the matrix that are not zero are not stored.

In connection with the storage of two matrices in a common matrix, it is possible, for example, in the case of an LR decomposition, not to store the lower left normalized triangular matrix L and the upper right triangular matrix R obtained by the LR decomposition separately as two matrices, but to store them together in one matrix, wherein the value 1 on the main diagonal of the L matrix is implicitly assumed.

In other words, it is preferably provided that the annotation information characterizes two matrices as an upper triangular matrix, lower triangular matrix, diagonal matrix, band matrix, matrix with equal values on the main diagonal, matrix with equal values on the secondary diagonal, unit matrix, symmetric matrix, sparse matrix, permutation matrix and/or regular matrix, and that when saving the two matrices, these are stored together in one matrix such that the non-zero elements of the first matrix are stored on the positions of the zero elements and/or on the positions having elements with value 1 of the second matrix and/or that the non-zero elements of the second matrix are stored on the positions of the zero elements and/or on the positions having elements with value 1 of the first matrix.

In connection with transposed matrices, the saving of a matrix M^{T} transposed to a matrix M can also be completely avoided, since transposing basically only changes the processing order. Instead of storing the transposed matrix M^{T} in memory and calculating a matrix-column matrix multiplication M^{T}×V=C with the transposed matrix M^{T} stored in memory, the matrix-column matrix multiplication M^{T}×V=C can be implemented by swapping the indexes when accessing the matrix M when calculating the matrix-column matrix multiplication. This conserves storage space on the one hand and runtime when copying the original matrix M on the other. Thus, according to a preferred further development, it is provided that when the control program is generated, the stored annotation information is taken into account in such a way that a processing sequence of matrix elements of the matrix is defined in the control program when the processing order that involves at least one matrix is implemented.

Another possibility to cut down on calculation steps and reduce the runtime of the control program accordingly is by using permutation of values of a row or column matrix. Usually, such a permutation is represented by a matrix multiplication of the corresponding column or row matrix with a permutation matrix, wherein in the permutation matrix in each row and in each column exactly one entry is one and all other entries are zero. However, due to the characteristic of the permutation matrix, in which only exactly one occurs in each column or row, determining the new positions of the values of the column or row matrix using comparisons is less computationally intensive than performing matrix multiplication. Accordingly, according to a preferred further development of the invention, it is provided that the annotation information describes the matrix as a permutation matrix and that the stored annotation information is taken into account when generating the control program in such a way that when implementing a processing order involving the permutation matrix and swapping positions of values of a column or row matrix, a matrix multiplication is replaced by a comparison on the target platform.

With regard to the annotation information, according to a preferred further development of the invention, it is provided that the annotation information is selected from the group comprising upper triangle matrix, lower triangle matrix, diagonal matrix, band matrix, matrix with equal values on the principal diagonal, matrix with equal values on the secondary diagonal, unit matrix, symmetric matrix, transposed matrix, permutation matrix and regular matrix. As the examples described above show, all these properties allow for the matrix to cut down on computational steps and/or conserve storage space.

In connection with the processing order, according to a further development of the invention, it is provided that the processing order involving at least one matrix is designed as matrix multiplication, inversion of a matrix, matrix addition, matrix subtraction, decomposition of a matrix and/or solution of a linear system of equations. The matrix multiplication preferably includes a multiplication of two or more matrices with each other, and also a multiplication of a matrix by a column or row matrix (i.e., a matrix with n=1 or m=1), which is also known as matrix-vector multiplication.

According to a preferred further development of the invention, the generation of the control program for the target platform from the graphical control model of the development platform includes the steps of creating an intermediate representation from the graphical control model, optimizing the intermediate representation generated, and generating the control program for the target platform by translating the optimized intermediate representation, wherein at least one of the steps is carried out taking into account the annotation information stored in the definition database.

Thus, a method for generating the control program for the target platform from the graphical control model of the development platform is preferably provided, in which the generation of the control program includes a transformation of the graphical control model into an intermediate representation, a preferably successive optimization of the intermediate representation and a translation of the optimized intermediate representation into the control program, wherein at least one of the steps is carried out taking into account the annotation information stored in the definition database. It is preferable to take the annotation information into account when creating the intermediate representation from the graphical control model. Because the annotation information is preferably taken into account during the transformation into the intermediate representation, all information of the graphical control model is still available.

In the intermediate representation, the blocks of the block diagram of the graphical control model are preferably translated into instructions with a fixed order of execution, whereby the structure of the intermediate representation semantically maps a textual programming language. The transform step can involve a number of sub steps, such as checking a number of rules and appending other code generation information. In principle, the omission of computational steps and/or the omission of access to the matrix can be done in any intermediate step of the transformation.

Advantageously, the method according to the invention takes into account the annotation information stored in the definition database for the construction of matrices used in the graphical control model when generating the intermediate representation in such a way that processing orders involving the matrix require fewer computational steps and/or the saving of the matrices is optimized. This not only creates more efficient code overall, but also accelerates optimization on the intermediate representation, as fewer computational operations have to be considered right from the start.

According to another further development of the invention, it is provided that the control program is generated in C code. In this case, C code can be understood to be a programming language that is based on C in terms of syntax and/or basic language structure. Such languages, for example, have statements terminated by semicolons, blocks of code separated by braces, parameters separated by brackets, and/or arithmetic and logical expressions defined in infix notation. They are sometimes also referred to as “languages with braces”. C Code preferably also includes code in the programming language C++, Handel-C and/or SA-C. Further preferably, it is understood to be a standardized form of C code such as ANSI C, ANSI C++, ISO C, ISO C++, Standard C and/or Standard C++, issued by the American National Standards Institute (ANSI), ISO/IEC JTC 1/SC 22/WG 14 of the International Organization for Standardization (ISO), ISO/IEC JTC 1/SC 22/WG 21 of “The C++ Standards Committee—ISOCPP” of the International Organization for Standardization (ISO) and/or the International Organization for Standardization (ISO) and/or the International Electrotechnical Commission (IEC).

The invention further relates to a method for configuring a target platform designed as a control unit, wherein the target platform comprises at least one computing unit, and preferably has at least one sensor and/or actuator for acquiring data of a physical process and/or acting on a physical process, comprising the steps of: importing a graphical control model of a development platform; generating a control program for the target platform from the read in graphical control model according to the method described above; generating an executable code for the computing unit of the target platform by compiling the generated control program; and/or transferring the generated executable code to the target platform and/or storing the generated executable code on a non-volatile memory of the target platform and/or executing the generated executable code by the computing unit of the target platform.

The control unit preferably includes an interface for connection to the development platform. Furthermore, the control unit preferably includes a microcontroller with an architecture different from a processor of the development platform, a working memory and a non-volatile memory. Furthermore, the control unit can also comprise more than one computing unit, for example a central processing unit and a computing unit adapted to matrix operations such as a tensor processing unit.

Furthermore, the invention relates to a device for data processing comprising means for executing the computer-implemented method for generating the control program described above.

Particularly preferred, the device includes a definition database for storing information about the graphical control model, and in particular for storing annotation information for the construction of matrices used in the graphical control model. The definition database can have a tree structure and/or be stored as a simple file in a memory of the device. Alternatively, it may be provided to store the definition data and annotation information in a dedicated database system.

Further, the invention relates to a computer program product comprising commands which, when executed by a computer, cause it to execute the computer-implemented method for generating the control program described above.

The invention also relates to a computer-readable medium on which the above computer program product is stored.

Preferably, the commands can be embedded on the computer-readable data carrier, and the commands, when executed by a processor on the computer, cause the processor to execute the method for generating the control program.

The technical advantages and effects of the method for configuring the target platform designed as a control unit, the device for data processing, the computer program product and the computer-readable data carrier are apparent to the skilled person from the description of the method for generating the control program, as well as from the embodiments described below.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a device for data processing, according to an example of the invention;

FIG. 2 schematically shows the software components installed on the device according to FIG. 1; and

FIG. 3 schematically shows a flowchart of a method for generating a control program for a target platform from a graphical control model, according to a preferred embodiment of the invention.

### DETAILED DESCRIPTION

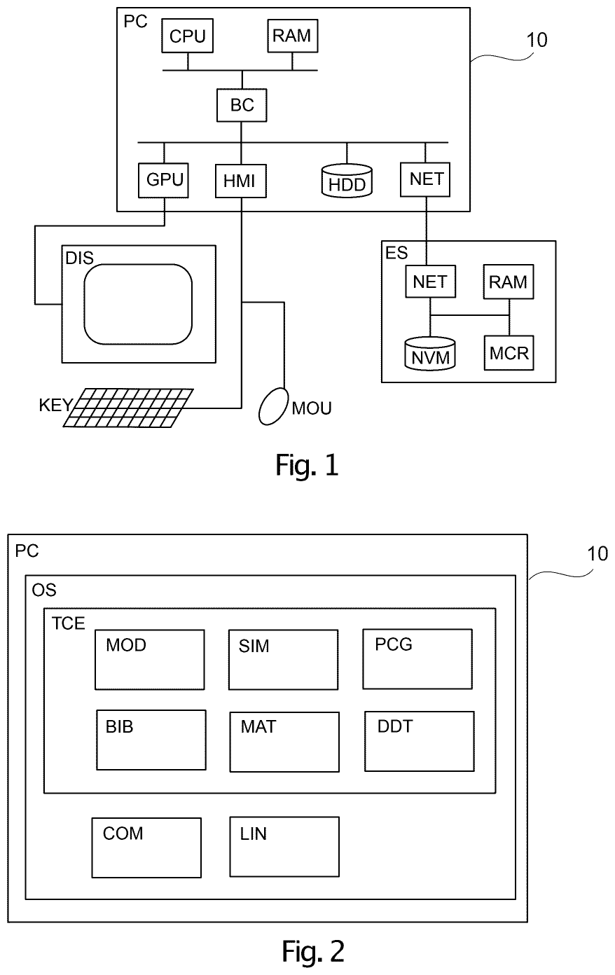

FIG. 1 schematically shows an exemplary design of a device for data processing 10, in this case called a computer system PC. The computer system PC is set up to execute a method for generating a control program for a target platform from a graphical control model of a development platform—i.e., the computer system. The computer system PC is designed to support matrix operations and has a processor CPU, which can be realized in particular as a multi-core processor, a random access memory RAM and a bus controller BC. The computer system PC is preferably designed to be operated manually directly by a user, with a graphics card GPU connecting a monitor DIS and a human-machine interface HMI connecting a keyboard KEY and a mouse MOU. In principle, the human-machine interface of the computer system PC could also be designed as a touch interface. The computer system PC also includes a non-volatile data memory HDD, which can be designed in particular as a hard disk and/or solid state disk, as well as an interface NET, in particular a network interface. A control unit ES—i.e., the target platform—can be connected via the interface NET. In principle, one or more interfaces, in particular wired interfaces, can be present on the computer system PC and can be used for connection with a control unit ES. It is expedient to use a network interface based on the Ethernet standard; The interface NET can also be designed wirelessly, in particular as a WLAN interface or according to a standard such as Bluetooth.

The control unit ES can be designed as a series control unit or as an evaluation board for the target platform. Conveniently, it includes an interface NET for connection to the computer system PC, a microcontroller MCR with an architecture different from the processor of the computer system PC, a random access memory RAM and a non-volatile memory NVM.

FIG. 2 shows a diagram of the software components preferably installed on the computer system PC. These use mechanisms of the operating system OS, for example, to access the non-volatile memory HDD or to establish a connection to an external computer and/or the control unit ES via the network interface NET.

A technical computing environment TCE enables the creation of models—in particular graphical control models and the generation of a control program, also known as source code, from the graphical control models. In a modeling environment MOD, graphical control models of a dynamic system can be created preferably via a graphical user interface. In particular, these can be block diagrams that comprise several blocks and describe the temporal behavior and/or internal states of a dynamic system. At least some of the blocks may be connected to each other by signal links, wherein the signal links are directed links for the exchange of data, the data being scalar or composite, and in particular may be designed as matrices. The blocks can be used to define operations and/or calculation steps to be performed on the data. In particular, matrix operations can be calculated within the blocks and/or data designed as matrices can be exchanged via the signal connections.

The computing environment TCE includes one or more libraries BIB, from which blocks or building blocks can be selected for the construction of a model. In a scripting environment MAT, statements can be entered interactively or via a batch file to perform calculations or modify the model. The computing environment TCE also includes a simulation environment SIM, which is set up to interpret or execute the block diagram in order to study the temporal behavior of the system. These calculations are preferably performed with high-precision floating-point numbers on one or more cores of the microprocessor CPU of the computer system PC.

From a created model, the source code can be generated preferably in a programming language such as C with the help of a code generator PCG. For this purpose, in the present embodiment, the method for generating a control program for a target platform from the graphical control model of the development platform is executed. Also, additional information on the model is stored in a definition database DDT, in particular the annotation information on the structure of the matrices used in the graphical control model.

Furthermore, other additional information about the model, such as information about the variables in the blocks—called block variables—can also be stored in the definition database DDT. The block variables can be assigned value ranges and/or scales to support a calculation of the model with fixed-point instructions. Desired properties of the source code, such as conformity to a standard such as MISRA, can also be set or stored in the definition database DDT. Each block variable can be assigned to a predefined variable type and/or one or more desired properties, e.g., the permissibility of optimizations such as a combination of variables, can be set.

The code generator PCG preferably evaluates the settings of the definition database DDT and in particular the stored annotation information and takes these into account when generating the source code. The definition database DDT can have a tree structure or be stored as a simple file in a memory of the computer system; alternatively, it may be provided to store the definition data in a dedicated database system. The definition database can have a program interface and/or import/export functions.

In this embodiment, the computer system PC has a compiler COM and a linker LIN, which are conveniently set up for the generation of binary files that can be executed on a control unit ES and/or the computer system PC. In principle, a large number of compilers can be available, especially cross compilers for different target platforms, in order to support control units or evaluation boards ES with different processor architectures.

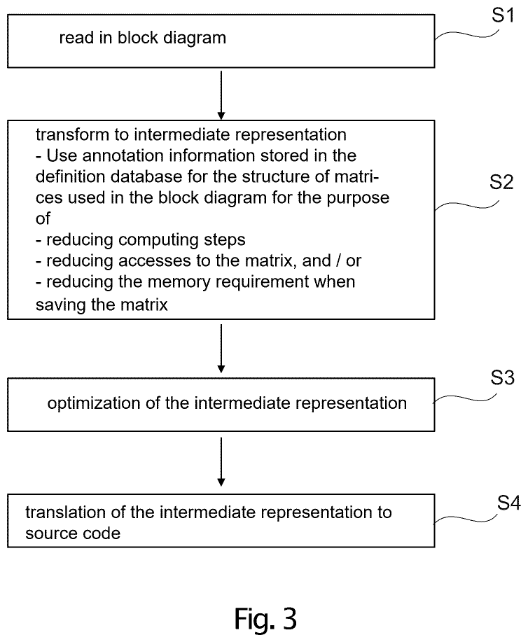

FIG. 3 shows a schematic flow chart of an example of the method according to the invention for generating a control program for a target platform from the graphical control model of the development platform. The method can be carried out entirely by a processor of an example of the computer system PC; however, it can also be provided for execution in a client-server environment with an operating computer and one or more servers connected via a network, wherein in particular computationally intensive steps are carried out on the servers.

In step S1 (read in block diagram), a graphical control model comprising a block diagram is read in. In the graphical control model, at least one matrix operation is performed. Conveniently, the reading in of the block diagram also includes reading out at least one annotation information for the structure of the matrix from the definition database DDT.

In step S2 (transform to intermediate representation), the graphical control model is transformed into an intermediate representation, preferably comprising one or more hierarchical graphs. In particular, this can be a data flow graph, a control flow graph or a tree structure. In addition to the block diagram, additional information from a definition database DDT is also taken into account or incorporated into the creation of the intermediate representation. This can also include situations where elements are created based on information in the definition database DDT, or where properties of elements or settings relevant to code generation are extracted from the definition database DDT.

In this embodiment, when transforming into the intermediate representation, the annotation information stored in the definition database for the structure of the matrices used in the graphical control model is taken into account in such a way that a) the computational speed is increased on the target platform when implementing the processing order involving at least one matrix and/or the memory requirement is reduced on the target platform when saving the matrices. This is implemented in the present case by omitting those calculation steps in matrix multiplications in which the component-by-component multiplication results in zero, on the one hand, and omitting those calculation steps in matrix additions and/or matrix subtractions in which two zero elements are added together or subtracted from each other. On the other hand, this is implemented in the present case by storing the matrix as an array when the matrix is stored on the target platform, and/or by storing two matrices together in one matrix.

With regard to the omission of those calculation steps in which the component-by-component multiplication results in zero, the following processing order for multiplying a 5×5 matrix by a 5×1 column matrix shows how the calculation steps are reduced when the annotation information is taken into account:

$$\begin{matrix}3 & 0 & 0 & 0 & 0 \\ 0 & 3 & 0 & 0 & 0 \\ 0 & 0 & 3 & 0 & 0 \\ 0 & 0 & 0 & 3 & 0 \\ 0 & 0 & 0 & 0 & 3\end{matrix} * \begin{matrix}2 \\ 3 \\ 4 \\ 5 \\ 6\end{matrix} = \begin{matrix}6 \\ 9 \\ 12 \\ 15 \\ 18\end{matrix}$$

Without knowledge of the structure of the matrix as a diagonal matrix with a value of 3 on the diagonal, the code for implementing the processing order should look like this:

$$For ( i = 0 ; i < 5 ; i ++ )$$

$$C [ i ] = A [ i , 0 ] * B [ i ] ;$$

$$For ( j = 1 ; j < 5 ; j ++ )$$

$$C [ i ] = C [ i ] + A [ i , j ] * B [ i ] ;$$

This corresponds to a total of 5*5=25 multiplications and 5*4=20 additions. However, since the method for generating the control program from the graphical control model takes the stored annotation information into account when generating the control program for the target platform, which characterizes the present matrix as a diagonal matrix with a constant value of 3 on the diagonal, the following source code is generated:

$$For ( i = 0 ; i < 5 ; i ++ )$$

$$C [ i ] = A [ i , i ] * B [ i ] ;$$

This corresponds to only 5 multiplications. In this example, only 5 multiplications are necessary, instead of 5*5 multiplications plus 4*5 additions, if in the general case no information about the structure of the matrix is known. Since the annotation information also shows that the values of the main diagonals are the same, 4 accesses to the matrix are eliminated, since the common value 3 is cached in a register:

$$For ( i = 0 ; i < 5 ; i ++ )$$

$$C [ i ] = 3 * B [ i ] ;$$

In terms of storing two matrices in one matrix on the target platform, the following example shows how to reduce the memory requirement:

In an LU decomposition of the matrix M, a left lower normalized triangular matrix L and an upper triangular matrix U are obtained.

$$M = \begin{matrix}7 & 8 & 9 \\ 1 & 2 & 3 \\ 4 & 5 & 6\end{matrix} L = \begin{matrix}1 & 0 & 0 \\ 0.1429 & 1 & 0 \\ 0.5714 & 0.5 & 1\end{matrix} U = \begin{matrix}7 & 8 & 9 \\ 0 & 0.8571 & 1.7143 \\ 0 & 0 & 0\end{matrix}$$

Instead of storing them individually, taking into account the annotation information, which characterizes the matrix L as a lower left normalized triangular matrix and characterizes the matrix U as an upper triangular matrix, both matrices L and U are stored in a matrix LU with the size 3×3:

$$LU = \begin{matrix}7 & 8 & 9 \\ 0.1429 & 0.8571 & 1.7143 \\ 0.5714 & 0.5 & 0\end{matrix}$$

Furthermore, in relation to storing a matrix as an array, reference is made to the following embodiment:

Instead of storing the diagonal matrix A of the size 5×5 as a matrix with 25 elements, the matrix is stored as an array M of the size 5, taking into account the annotation information that characterizes the matrix as a diagonal matrix:

$$A = \begin{matrix}2 & 0 & 0 & 0 & 0 \\ 0 & 3 & 0 & 0 & 0 \\ 0 & 0 & 4 & 0 & 0 \\ 0 & 0 & 0 & 5 & 0 \\ 0 & 0 & 0 & 0 & 6\end{matrix} M = \begin{matrix}2 & 3 & 4 & 5 & 6\end{matrix}$$

In addition, in the present embodiment, the stored annotation information is taken into account in relation to increasing the computing speed when the control program is generated in such a way that a processing sequence of matrix elements of the matrix is defined in the control program when the processing order that involves at least one matrix is implemented, as illustrated by the following example:

Specified is a matrix M as well as the processing order M^{T}×V=C involving the transposed M^{T} of the matrix M, in which the matrix M^{T} is multiplied by the column matrix V.

$$M = \begin{matrix}7 & 8 & 9 \\ 1 & 2 & 3 \\ 4 & 5 & 6\end{matrix}$$

Without taking into account the annotation information, the processing order can only be implemented in such a way that the transposed matrix M^{T} is explicitly calculated and stored in the memory:

$$For ( i = 0 ; i < 3 ; i ++ )$$

$$C [ i ] = {M}^{T} [ i , 0 ] * V [ i ] ;$$

$$For ( j = 1 ; j < 3 ; j ++ )$$

$$- C [ i ] = C [ i ] + {M}^{T} [ i , j ] * V [ i ] ;$$

$${M}^{T} = \begin{matrix}7 & 1 & 4 \\ 8 & 2 & 5 \\ 9 & 3 & 6\end{matrix}$$

Then, the processing order M^{T}×V=C can be executed:

$$For ( i = 0 ; i < 3 ; i ++ )$$

$$C [ i ] = {M}^{T} [ i , 0 ] * V [ i ] ;$$

$$For ( j = 1 ; j < 3 ; j ++ )$$

$$- C [ i ] = C [ i ] + {M}^{T} [ i , j ] * V [ i ] ;$$

Taking into account the annotation information that describes the matrix M^{T} as a transpose of the matrix M, the processing order M^{T}×V=C is implemented directly by swapping the indices when accessing the matrix M:

$$For ( i = 0 ; i < 3 ; i ++ )$$

$$C [ i ] = M [ 0 , i ] * V [ i ] ;$$

$$For ( j = 1 ; j < 3 ; j ++ )$$

$$- C [ i ] = C [ i ] + M [ j , i ] * V [ i ] ;$$

This conserves both memory space and reduces runtime when copying the original matrix M.

Back to FIG. 3, step S3 (further optimization intermediate representation) optimizes the intermediate representation and in particular optimizes the hierarchical graphs in order to reduce the number of required variables and/or memory consumption, such as a stack allocation, and/or the number of operations or processor instructions and/or the execution time of the source code. This optimization can include a large number of intermediate steps in which further intermediate representations are created between the model/block diagram and the source code/program text. In particular, it may be provided to convert a set of original hierarchical graphs to a different set of modified hierarchical graphs in each intermediate step, applying one or more optimization rules. Various strategies such as “constant folding” or elimination of “dead code” can be used during optimization. In principle, it is possible to combine several variables created as part of the transformation in step S3.

In step S4 (translate intermediate representation into source code), the optimized intermediate representation or the optimized hierarchical graphs, which result from the entire intermediate steps performed, are translated into source code of a textual programming language, in this case C code. In this step, too, further optimization can be carried out, in particular in such a way that the generated instructions represent a subset of the instructions that are in principle encompassed by the language and/or the generated control structures represent a subset of the control structures that are in principle encompassed by the language. This makes it possible to meet precisely defined rules. Alternatively or in addition, it may be provided to generate additional information, such as a reference between the program line and the block diagram, and to integrate it into the source code, especially in the form of comments, in order to improve the readability of the source code and/or simplify debugging.

During or after code generation, information about the block diagram or results of the code generation, such as reduced calculation steps or generated warnings, can be stored in the definition database DDT. This information can be used, for example, to influence a compilation of the generated source code or to provide meta information for other tools, such as calibration information in ASAP2 format or information on how to create an intermediate layer according to the AUTOSAR standard.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for generating a control program for a target platform from a graphical control model of a development platform, the development platform comprising a definition database for storing information on the graphical control model and is designed to support matrix operations, the method comprising:
storing annotation information for the structure of matrices used in the graphical control model in the definition database; and
taking into account, when the control program for the target platform is generated, the stored annotation information such that:
on the target platform when implementing a processing order that involves at least one matrix, the computing speed is increased; and/or
on the target platform when saving the matrices, the memory requirement is reduced.

2. The method according to claim 1, wherein the stored annotation information is taken into account when generating the control program in such a way that when the processing order involving at least one matrix is implemented, fewer calculation steps are required, and/or fewer accesses to the matrix are required on the target platform.

3. The method according to claim 1, wherein the target platform comprises at least two computing units for the conversion of processing orders, wherein the stored annotation information is taken into account when generating the control program in such a way that it is determined which of the computing units is used for the implementation of the processing order which involves at least one matrix.

4. The method according to claim 1, wherein the stored annotation information is taken into account when generating the control program in such a way that when the matrix is stored on the target platform a matrix is stored as an array or two matrices are stored together in one matrix.

5. The method according to claim 1, wherein the stored annotation information is taken into account when the control program is generated in such a way that a processing sequence of matrix elements of the matrix is defined in the control program when the processing order involving at least one matrix is implemented.

6. The method according to claim 1, wherein the annotation information describes the matrix as a permutation matrix and the stored annotation information is taken into account when generating the control program in such a way that when implementing a processing order involving the permutation matrix and swapping positions of values of a column or row matrix, a matrix multiplication is replaced by a comparison on the target platform.

7. The method according to claim 1, wherein the annotation information is selected from the group comprising an upper triangle matrix, a lower triangle matrix, a diagonal matrix, a band matrix, a matrix with equal values on the main diagonal, a matrix with equal values on the secondary diagonal, a unit matrix, a symmetric matrix, a transposed matrix, a permutation matrix, and/or regular matrix.

8. The method according to claim 1, wherein the processing order involving at least one matrix is designed as matrix multiplication, inversion of a matrix, matrix addition, matrix subtraction, decomposition of a matrix and/or solution of a linear system of equations.

9. The method according to claim 1, wherein the generation of the control program for the target platform from the graphical control model of the development platform comprises:
creating an intermediate representation from the graphical control model;
optimizing the intermediate representation generated; and
generating the control program for the target platform by translating the optimized intermediate representation,
wherein at least one of the steps is carried out taking into account the annotation information stored in the definition database.

10. The method according to claim 1, wherein the control program is generated in C code.

11. A Method for configuring a target platform designed as a control unit (ES), wherein the target platform comprises at least one computing unit (MCR) and preferably has at least one sensor and/or actuator in order to acquire data of a physical process and/or act on a physical process, the method comprising:
reading in a graphical control model of a development platform;
generating a control program for the target platform from the read in graphical control model according to the method according to any one of the preceding claims;
generating an executable code for the computing unit (MCR) of the target platform by compiling the generated control program; and
transferring the generated executable code to the target platform and/or storing the generated executable code on a non-volatile memory (NVM) of the target platform and/or executing the generated executable code by the computing unit (MCR) of the target platform.

12. A device for data processing comprising a processor for executing the method according to claim 1.

13. A computer program product, comprising commands which, when executed by a computer, cause the computer to execute the method according to claim 1.

14. A computer-readable medium on which the computer program product according to claim 13 is stored.
